(19) United States
(12) Patent Application Publication
(10) Pub. No.: US 2009/0141807 A1
(43) Pub. Date: Jun. 4, 2009

(54) Arrangements for processing video

(75) Inventors: Heinz Gerald Krottendorfer, Vienna (AT); Karl Heinz Grabner, Probstdorf (AT); Gerald Kolar, Vienna (AT)

Correspondence Address: Alan Carlson, 6202 Lynn Lane, Lago Vista, TX, 78645, US

(73) Assignee: On Demand Microelectronics

(21) Appl. No.: 11/880,016

(22) Filed: Jul. 19, 2007

Related U.S. Application Data
(60) Provisional application No. 60/807,829, filed on Jul. 20, 2006.

(51) Int. Cl. H04N 11/02; H04N 7/26

(52) U.S. Cl. 375/240.25; 375/240.26; 375/E07.027

(57) ABSTRACT

In some embodiments a system for processing video is disclosed. The system can include a video encoder/decoder module to accept video and to provide at least a portion of encoding functions on the video in a first mode and to perform at least a portion of decoding functions on video in a second mode. The system can also include an image processing module coupled to the video encoder/decoder, the image processing module having multiple modules to process images contained in the video. In addition the system can include a control unit coupled to the video encoder/decoder and the image processing module to determine an encoding mode of the encoder/decoder and to allocate resources of the image processing module to assist in encoding video. Other embodiments are disclosed.

### FIELD

This disclosure relates to video processing systems and further to arrangements for processing video.

### BACKGROUND

Real-time video applications can require a lot of processing power and typically provide considerable data throughput. The necessary processing power strongly depends on the video application, including the video standard utilized, the resolution, and the frame rate. Although the demands on the software and hardware for video applications have continuously increased, chip area generally has not, making power consumption and heat dissipation key challenges for designers in these modern designs.

Devices that can display video such as multimedia devices typically include basic components of a video system such as a video encoder, a video decoder, and an image processor. Thus, devices such as video capable radio telephones, video cameras, palm computers and portable media players with displays commonly include these components. There are two basic design approaches how video applications are implemented today. One approach is to run video applications on a general purpose data processing platform that has a sufficient amount of processing power. The drawback of such implementations are that general purpose architectures are not especially designed for video applications typically require a large chip area, have a relatively high power consumption and a high overhead because such systems are not specialized and are not designed and built and have specifically for video applications. Such general purposes systems do not work well where size is critical for example in a radio telephone.

Another approach for video processing designs is to select subsystems separately and combine these separately implemented functionalities to suit a specific application, design or specific need of the consumer. It can be appreciated that a custom approach can optimize functionality, can be smaller and can prove very economical. Possible drawbacks of such custom implementations are that synergies between subsystems sometimes cannot be exploited and chip area and power consumption can also cause problems.

In addition, areas on the chip that are specialized for video processing often cannot be utilized to perform other functions such as input output functions and other digital signal processing. Thus, specialized video processing resources may be idle at times because they are so specialized they cannot be effectively utilized for general data processing. In this arrangement, the idle components dissipate power and take up chip area while not contributing to the system bandwidth. For example, a device with a video decoder may exclusively use this subsystem as a decoder.

### SUMMARY OF THE INVENTION

In some embodiments a system for processing video is disclosed. The system can include a video encoder/decoder module to accept video and to provide at least a portion of encoding functions on the video in a first mode and to perform at least a portion of decoding functions on video in a second mode. The system can also include an image processing module coupled to the video encoder/decoder, the image processing module having multiple modules to process images contained in the video. In addition the system can include a control unit coupled to the video encoder/decoder and the image processing module to determine an encoding mode of the encoder/decoder and to allocate resources of the image processing module to assist in encoding video.

In another embodiment a method is disclosed. The method can include receiving coded video, decoding the video with a decoder, processing images with an image processor, receiving un-coded video data at a video encoder, and decoding the un-coded video utilizing the image processor and the encoder. In addition the method can determine that re-allocating processing resources can improve operating efficiency. Further the method can share pixel data between the image processor and the encoder.

In other embodiments, a programmable multiprocessor architecture for real time video processing is disclosed which allows significant size reduction compared to traditional configurations. The apparatus described in the present disclosure comprises a video encoder, a video decoder, and an image processor. The apparatus can include and encoder/decoder and an image processor. In a first mode of operation, the encoder/decoder can operate as a decoder. The image processor can be responsible for real time image processing of the video stream which has been decoder by the encoder/encoder.

In a second mode of operation, the apparatus can be operated as a video encoder. In the second mode, the image processor can operate a less complex image processing routine such that a processor or the image processor has processing resources that can be re-allocated to perform tasks associated with decoding. It can be appreciated that a video encoding can require more processing power than video decoding. Further, during an encoding process for smaller displays the image processor can run at a simplified or reduced instruction set and loan out resources that can assist in encoding video data.

For example, the image processor can process video data that is ancillary to encoding such as calculating motion compensation. Therefore, in the second mode of operation algorithms of the video encoder which can be efficiently processed by the image processing are implemented by at least a portion of the image processor. One analysis has shown that usually less complex image processing algorithms can be applied in parallel when a video stream is encoded. Therefore, processing requirements of less complexity can be applied to the image processor. For example, the video data can be down-scaled to provide a lower-resolution video-output stream when a low-resolution thin film transistor (TFT) display is utilized. Hence, resources from the image processor, such as a co-processor, can be dynamically assigned to process tasks such as motion estimation that would normally be performed by the encoder/decoder during an encoding mode. Thus, the image processor can perform at least a portion of the video encoding particularly for tasks that have a relationship with image processing algorithms.

### BRIEF DESCRIPTION OF THE DRAWINGS

FIG. 1 is a block diagram of a video processing system operating in a first mode;

FIG. 2 is a block diagram of a video processing system operating in a second mode;

FIG. 3 is another block diagram of a video processing system operating in the first mode;

FIG. 4 is another block diagram of a video processing system operating in the second mode;

FIG. 5 is a more detailed block diagram of a video processing system; and,

FIG. 6 is a flow diagram illustrating a method for operating a video processing system.

### DETAILED DESCRIPTION OF THE PREFERRED EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

While specific embodiments will be described below with reference to particular configurations of hardware and/or software, those of skill in the art will realize that embodiments of the present disclosure may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

In some embodiments, arrangements that may provide real-time video decoding with comprehensive real-time image processing or real-time video encoding with simple or no real-time image processing are disclosed. This arrangement can reduce the required chip area when compared to conventional implementations such as the ones described above.

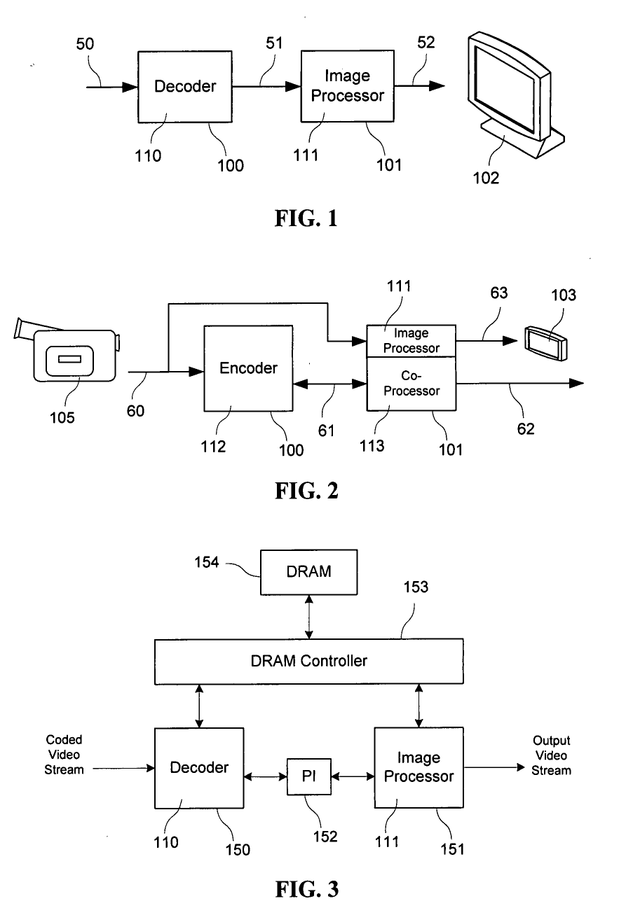

Referring to FIG. 1, a dual function processing architecture is disclosed. The architecture can include an encoder/decoder module 100 and an image processing module 101 and the architecture can support at least two modes of operation. The modules 100 and 101 can be programmable hardware architectures, such as analog and digital signal processors and can support compression and decompression processes. The module 101 can include configurable image processing function groups where the image processing function groups can be implemented in dedicated hardware. The image processing function groups can include de-interlacing, scaling, sharpening, de-blocking, brightness corrections, contrast corrections, median filter, and/or color-conversion.

A first mode of operation can be a real-time video mode. In this mode decoder module 100 can include a real-time video decoder 110 which can receive and decode an encoded video stream 50 and can send the decoded video stream 51 to image processing module 101. In the first mode of operation, the image processing module 101 can include a real time image processor 111 which can receive the decoded video stream 51, can perform image processing algorithms such as listed above for module 101 on the video stream 51, and can send the processed video stream 52 to one or more subsequent devices, such as display device 102.

Referring to FIG. 2, a second mode of operation is depicted. In this embodiment encoder/decoder module 100 can operate as a real-time video encoder 112 which can receive and encode an un-coded video stream 60 from an external source. The external source can be any source that can provide video data such as a video camera 105. Generally, a real-time encoder requires more processing power than a real-time decoder. Thus, in another mode, encoder/decoder module 100 can use or borrow processing resources from image processor module 101.

Data that needs processing that is related to encoding can be communicated between encoder/decoder 100 and co-processor 113 via line 61. This resource sharing allows unutilized processing power in the image processor 101 to be exploited such that the system as a whole can operate at a higher bandwidth and provide higher quality video to a display. Such additional bandwidth can be effectively utilized when the system is performing real-time encoding. Accordingly, in some embodiments, the resources of image processor 111 that are not utilized or do not have a high priority can be allocated to assist the encoder/decoder 100 in encoding video data as a co-processor 113. The resource could be shared and allocated based on a bartering or a priority system or can be assigned statically to the image processor 111 or the co-processor depending on the mode of operation.

Generally, in an encoding process, various forms of data can be exchanged over line 61. Line 61 can be used to transfer trigger signals, commands, parameters, image-related data, or other data between encoder 112, module 101 and co-processor 113. Trigger signals can be utilized to control the image processor 111 such that it can start de-interlacing when at least two images of a series of images in a video stream are available. Alternately the trigger signal can control the image processor 111 to start an image enhancement algorithms (such as sharpening or contrast) when enough video data is available. Image related data can be data such as motion vector data that have been calculated by the co-processor 113, commands can be sent from the encoder to the co-processor, and parameters can be either configuration parameters for the co-processor or parameters that are supplied with the commands. The encoded video stream 62 can be sent to one or more external devices, possibly a storage device (not shown).

The image processor 111 can perform on un-coded streaming video data 520 image processing algorithms of the module 101 that are not assigned as a co-processor 113 to the encoder 112. The results of such processing can be sent as a processed video stream 63 to a device such as a smaller portable display having a thin film transistor (TFT) type display 103.

Modules 100 and 101 may contain at least one programmable device and in addition may contain hardware accelerators. Module 100 can be a hardware architecture that is suitable to run a real-time video decoder or certain parts of a real-time video encoder. Module 101 can be a hardware architecture that is suitable to run real-time image processing algorithms and certain parts of a real-time video encoder and can be configured as a parallel processor architecture.

FIG. 3 illustrates a more detailed video processing system based on the system illustrated in FIG. 1 as it can operate in the first mode which does not share resources. The system can include two processors 150 and 151, a processor interface 152, a DRAM controller 153, and memory 154. Decoder 110 can include a processor 150 that perform decoding and image processor 111 can have a processor 151 that can perform image processing. The decoder 110 can receive and decode the coded video stream and can send the decoded stream to DRAM controller 153 which can store the data in memory 154. Memory could be dynamic random access memory (DRAM). The image processor 111 can read the video stream from the memory 154 using memory controller 153 and can send the processed output video stream to other devices, such as devices that can display the video (not shown). The processor interface 152 can be utilized for synchronization or communication purposes.

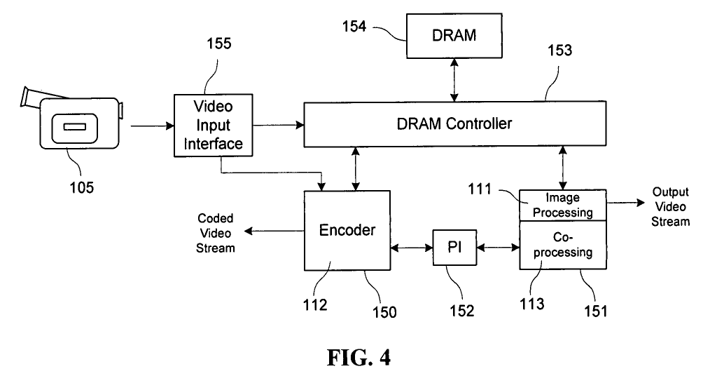

Referring to FIG. 4 an embodiment having an encoder and features similar to FIG. 2 is disclosed. Processor 150 can perform primarily as an encoder 112 and the processor 151 both perform as an image processor 111 and as a co-processor 113 for the encoder 112. The video input interface 155 can receive streaming video data, typically un-coded data from an external device, such as a video camera 105, and can send the stream to the memory controller 153 and to memory 154, where the data can be stored. The encoder 112 can simultaneously read the un-coded data of the video stream from the memory 154 using the memory controller 153, can encode the video data in the stream, and can send streaming coded video data to another device, such as an external storage device.

The co-processor 113 can provide certain functions to the encoder 112, such as motion estimation algorithms or floating point operations, where the encoder 112 and the co-processor 113 can exchange data through the processor interface 152. Memory 154 can store video data, temporary data, and image processed output video data. During such an exchange, the image processor 111 can read the streaming video data from memory 154 via memory controller 153. In some embodiments image processor 111 can perform image processing on the streaming video stream data, such as downscaling algorithms or color-conversion algorithms. In some embodiments, when image processing is occurring on the image processor 111, it can consume processing resources of module 151 and can reduce the processing resources of the image processor 111 and thus reduce the processing power available for co-processing 113. The image processor 111 can send the processed video stream to other devices, such as a device with display capabilities (not shown). In other embodiments the resources of the module 151 can be assigned statically to the image processor and the coprocessor depending on the mode of operation.

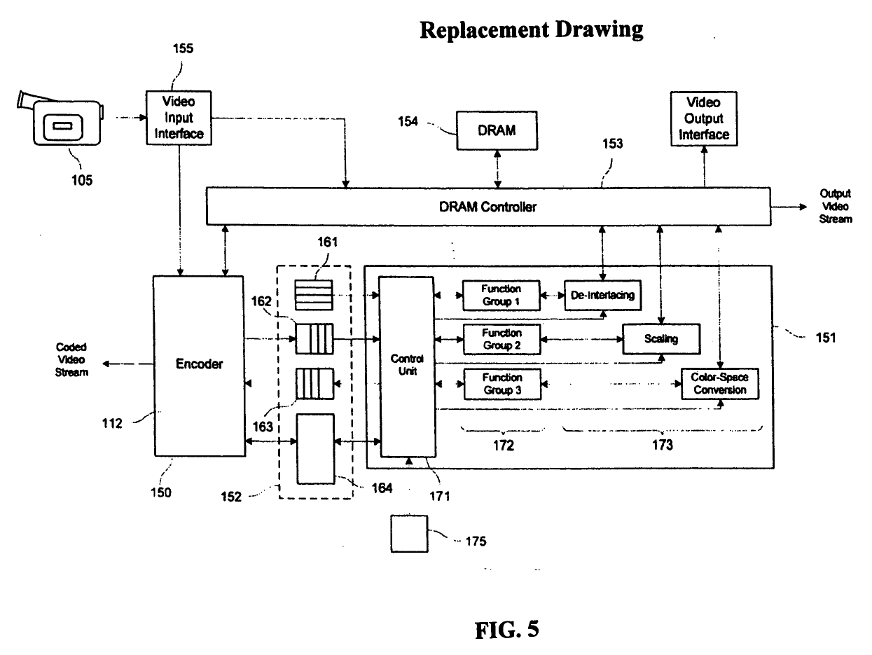

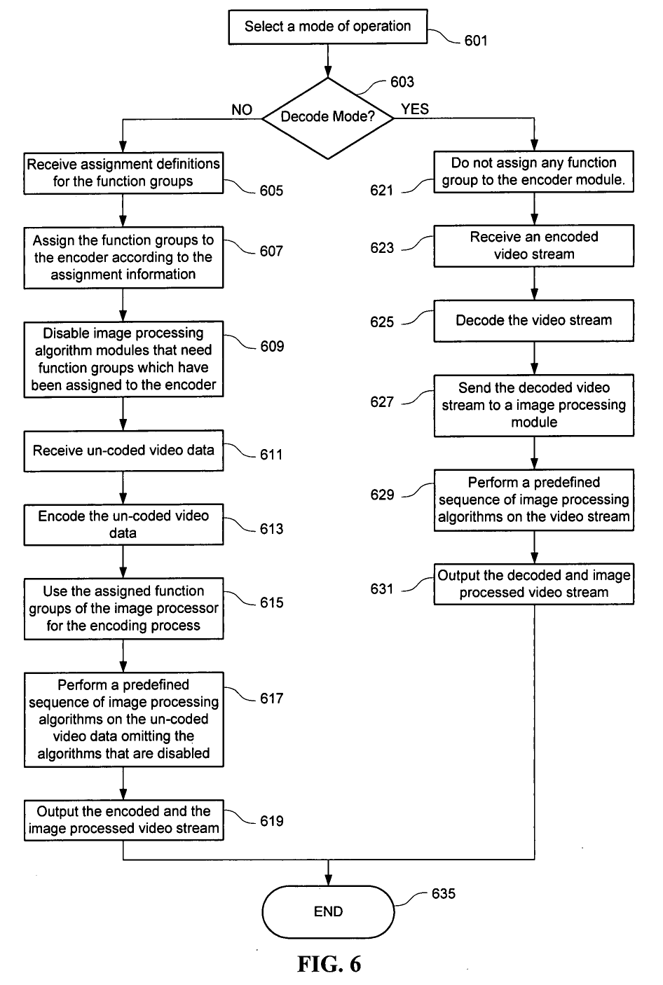

FIG. 5 illustrates a processing architecture that can be utilized to process video. Module 151 can provide image processing and can include a control unit 171, a plurality of function groups 172, and a plurality of image processing modules 173. Each image processing module 173 can allow module 151 to provide or execute selectable specialized image processing features. The activation and deactivation of each image processing module (173) can be controlled by the control unit 171. Modules 173 can provide numerous specialized operations that are related to video data including de-interlacing, scaling, color-space conversion algorithms and other image and encoding type functions.

A function group can be an algorithm that can be used by an image processing module and encoder 112. Modules 173 could be implemented in hardware as processors or co-processors. As illustrated, each module 173 can utilize one function group 172, however, in some embodiments each module 173 can use or execute more than one function group 172. It can be appreciated that function groups can include multiple algorithms. In one example function group 1 may be a motion estimation algorithm, function group 2 may be a set of floating point operations, and function group 3 may be a set of memory operations.

Each module 173 can be controlled by a control unit 171. Module 173 can read definitions from a control definition module 175 which can provide control signals that can control the assignment of a function group 172 to the encoder 112 or to its corresponding image processing module 173. When a function group 172 is assigned to a corresponding module 173, the assigned module can provide functionality for image processing as it can “own” its corresponding function group 172.

In the case where a function group 172 is assigned to the encoder 112, the corresponding module 173 can be removed from the pool of available image processing algorithms useable by image processor module 151. The assignment of function groups to either the encoder 112 or an image processing algorithm module 173 can be controlled by control unit 171 which can read assignment definitions from control definition module 175. These assignments can, in some embodiments be static until the control unit 171 receives a trigger signal from an external control system (not shown). The trigger signal can activate the control unit 171 such that the control unit can read new definitions from control definitions module 175 based on the trigger or the type of trigger. In some embodiments dynamic allocation can occur.

In a first mode of operation, module 150 can run a decoder and module 151 can operate as an image processor. In some embodiments of this mode, control unit 171 may not have to request assignments definitions from the definition module 175 and may make no assignments. Thus, in a decoding mode control unit 171 can be idle and may not assign function groups 172 to the module 150. In a second mode of operation or during encoding, module 150 can run an encoder and can require additional processing power from function groups 172. When encoding is occurring or is about to occur, definition module 175 can, be queried by control unit 171 and provide assignment information that can be utilized by the control unit 171 to assign function groups 172 to the encoder 112. The control unit 171 can tag function groups 172 that are or will be assigned to the encoder 112. Such tagged function groups can be recognized by the image processor 151 and correspondingly image processing modules 173 as unavailable for use by the image processor 151.

The processor interface 152 can support control communications between the encoder 112 and the image processor 151. The processor interface 152 can include a command definition table 161, an output queue 162 for decoder 112, an output queue 163 for image processor or module 151, and memory 164 that can store data for from both modules 150 and 151. Such data can include pixel data that can be shared between and among modules 150 and 151. Such data can also be part of the image that currently being processed by both modules 150 and 151. Command definition table 161 can contain a list of commands that can be made available to the module 150 via module 151. A command in the list of commands can be function group of the module 151 that uses special parameters.

As stated above, one example of a function group can be a motion estimation algorithm and a command or command definition can be border for the area which is undergoing motion estimation. For example, a command might be motion estimation with 3 pixel border, while another command may be motion estimation with an 8 pixel border. It can be appreciated however, that many command and parameters could be utilized without parting from the scope of this disclosure. In some embodiments, commands in table 161 can be defined with an identifier denoting the function group 172 that the command is associated with, the number of parameters expected for the command, configuration parameters for the function group and additional configuration parameters for the control unit 171.

The encoder 112 can use module 162 to send commands to the co-processor in module 151. Module 162 can be a queue that can receive a maximum of N commands. In the encoding mode, control unit 171 can receive commands from the queue 162. Each such command can comprise of the number of the command, whereas the number can be an index to a command definition stored by table 161 specifying the entry in the table 161 which defines the command as described above. Moreover, each command provided in the queue 162 can have a defined number of parameters. The control unit 171 can load the command definition from the definition table 161 using the index and can provide all parameters and configurational parameters to the specified function group 172.

The function groups 172 can also use module 163 to return the calculated values to the encoder 112. Module 163 can be a queue, having N entries. Once a function group that has executed a command retrieved from module 162 it can return the value or the series of values to the encoder using the queue 163 using a unique number that has been assigned by the encoder 112 to each command it queues to a function group. This unique number can be used to assign a return value to a command issued some clock cycles before.

Therefore, the definitions stored in the definition module 175 which are loaded and executed by the control module 171 can act as switches which allow to flexible assignment of processing functions 172 to processing modules 150 or 151.

It can be appreciated that the decoder/encoder 150 and the image processor 151 can be highly optimized for processing video. Despite such optimization, the decoder/encoder 150 and image processor 151 can be implemented with minimal chip area as compared to traditional implementations. In some embodiments, optimization can be achieved by assigning specific algorithms to specific specialized modules which when utilized with other modules provide synergies based on the specialized architecture of the hardware and the specific algorithms.

For example, encoder/decoder 150 and image processor 151 can be implemented as a highly parallelized processing structure. In some embodiments, modules 150 and/or 151 can be implemented as a parallel processing unit to process single instruction multiple data (SIMD) type instructions. In other embodiments each function of the module 151 can be performed by dedicated/specialized hardware, such as combinatorial logic or processing units, that is explicitly developed for its task. The disclosed arrangements can allow for each module (150 and 151) to flexibly assign processing power to image processor 151, depending on the mode of operation of the system, and the strengths and characteristics of the processing resources.

Accordingly control unit could set or determining priorities for allocating resources or function groups between modules 150 and 151. For example, resources can be allocated based on an arrangement that matches a resource to a task where the resource (portion of module 150 or 151) that is the most qualified or can process the task more efficiently than other available resources, can be allocated or re-allocated. This priority/best fit arrangement enables functions or applications to make use of the special properties or specializations of particular modules. Accordingly, the encoder/decoder 150 can “farm out” both sequential type algorithms as well as parallelizable type algorithms to different subsystems or modules based on a specialty or an architecture of the module or based on a modules processing capabilities.

Referring to FIG. 6 a flow diagram of a method for processing is disclosed. As illustrated by block 601, a mode of operation can be selected. The mode of operation can be a decode mode with subsequent image-processing or encoding of un-coded video data with image processing of the un-coded video data. As illustrated by decision block 603, it can be determined if a decode mode has been selected. If the decode mode has been selected no function groups can be re-allocated or assigned to the encoder module as illustrated by block 621.

As illustrated by block 623, an encoded video stream can be received. This video stream can be decoded as illustrated by block 625. As illustrated by block 627, the decoded video stream can be sent to an image processing module. The image processing module can perform a number of image processing algorithms on the decoded video stream whereas the image processing algorithms can be performed in a predefined sequence which is illustrated by block 629. As illustrated by block 631, the so decoded and image processed video stream can be output.

If as determined at decision block 603, an encode mode has been selected, assignment definitions can be loaded as illustrated by block 605. This assignment definition can be utilized to assign function groups to the encoder module which is illustrated by block 607. As illustrated by block 609, all image processing algorithm modules can be disabled that use a function group that has been assigned to the encoder module. Un-coded video data can be received as illustrated by block 611. As illustrated by block 613, the un-coded video data can be encoded. For the encoding process, the encoder can use the function groups that have been assigned to the encoder module, as illustrated by block 615. As illustrated by block 617, the image processing module can perform a number of image processing algorithms on the un-coded video data where the sequence in which the image processing algorithms are processed can be predefined or predetermined. The borrowed function groups can be tagged as unavailable. As illustrated by block 619 both the encoded and the image processed video stream can be output. The method can end at block 635.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present disclosure, represent embodiments of the present disclosure.

The disclosed embodiments can take the form of an entirely hardware embodiment, an entirely software embodiment or an embodiment containing both hardware and software elements. In one embodiment, the arrangements can be implemented in software, which includes but is not limited to firmware, resident software, microcode, etc. Furthermore, the disclosure can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

Any input stream can be retrieved from and any output stream can be written to an electronic storage medium. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present disclosure contemplates methods, systems, and media that can automatically tune a transmission line. It is understood that the form of the arrangements shown and described in the detailed description and the drawings are to be taken merely as examples. It is intended that the following claims be interpreted broadly to embrace all the variations of the example embodiments disclosed.

What is claimed is:

1. A system comprising:
a video encoder/decoder module to accept video and to provide at least a portion of encoding functions on the video in a first mode and to perform at least a portion of decoding functions on video in a second mode;
an image processing module coupled to the video encoder/decoder, the image processing module having multiple modules to process images contained in the video;
a control unit coupled to the video encoder/decoder and the image processing module to determine an encoding mode of the encoder/decoder and to allocate resources of the image processing module to assist in encoding video.

2. The system of claim 1, further comprising a processor interface to facilitate interactions between the encoder/decoder and the image processing module

3. The system of claim 2, wherein the processor interface comprises a command table to provide function groups that can be re-allocated between the encoder/decoder and the image processor.

4. The system of claim 1, further comprising a tagger to tag function groups that have been allocated.

5. The system of claim 1, wherein the image processing module can flag a resource as an available resource.

6. The system of claim 1, further comprising a control definitions module to provide control signals to the control unit.

7. The system of claim 1, wherein function groups are reallocated and the function groups can include functions including de-interlacing, scaling, color space conversion, motion estimation, sharpening, de-blocking, brightness corrections, contrast corrections, and median filtering.

8. The system of claim 1, further comprising a memory controller and memory coupled to the encoder/decoder and the image processor.

9. A method comprising:
receiving coded video;
decoding the video with a decoder;
processing images with an image processor;
receiving un-coded video data at a video encoder; and
decoding the un-coded video utilizing the image processor and the encoder.

10. The method of claim 9, further comprising determining that re-allocating processing resources can improve operating efficiency.

11. The method of claim 9, further comprising sharing pixel data between the image processor and the encoder.

12. The method of claim 9, further comprising reallocating resources based on predetermined re-allocation assignments.

13. The method of claim 9, further comprising reallocating processing resources based on an encoding workload.

14. The method of claim 9, further comprising reallocating image processing resources wherein reallocating comprises reallocating a portion of an integrated circuit that performs image processing to encode video data.

15. The method of claim 9 further comprising reallocating function groups.

16. The method of claim 9, further comprising tagging a reallocated function group such that the reallocated function group can be identified.

17. A system comprising:
an encoder to receive un-coded video;
an image processing module to process un-coded images; and
a control unit to allocate resources of the image processing unit to perform functions of video encoding when the encoder is encoding, the functions separated into groups.

18. The system of claim 17, further comprising memory to store control instructions for the control unit.

19. The system of claim 17, further comprising a processor interface to facilitate video processing transactions between the encoder and the image processor.

20. The system of claim 17, wherein the functions include one of de-interlacing, scaling, color space conversion, motion estimation, sharpening, de-blocking, brightness corrections, contrast corrections, and median filtering.
